(19) United States
(12) Patent Application Publication
(10) Pub. No.: US 2016/0285328 A1
(43) Pub. Date: Sep. 29, 2016

(54) ROTOR, MOTOR INCLUDING THE SAME, AND METHOD OF MANUFACTURING THE SAME

(71) Applicants: Samsung Electronics Co., Ltd., Gyeonggi-do (KR); Industry - University Cooperation Foundation Hanyang University (IUCF-HYU), Seoul (KR)

(72) Inventors: Sun Jin Kim, Gyeonggi-do (KR); Ju Lee, Seoul (KR); Jun Yeong Kim, Chungcheongnam-do (KR); Jin Han Kim, Gyeonggi-do (KR); Hyun Soo Park, Seoul (KR); Tae Chul Jeong, Seoul (KR)

(21) Appl. No.: 15/081,632

(22) Filed: Mar. 25, 2016

(30) Foreign Application Priority Data
Mar. 25, 2015 (KR) 10-2015-0041336

(51) Int. Cl. H02K 1/27; H02K 15/03

(52) U.S. Cl. CPC H02K 1/276; H02K 15/03

(57) ABSTRACT

Provided are a rotor including a demagnetization prevention barrier for preventing the demagnetization of a permanent magnet which is buried along the circumference, a motor including the rotor, and a method of manufacturing the rotor, the rotor including a rotor core provided to be rotatable by attraction and repulsion applied from an outside, a plurality of permanent magnets buried along a circumference of the rotor core to extend in a different direction from a radial direction of the rotor core, and a plurality of demagnetization prevention barriers installed to be spaced apart from both ends of each of the plurality of permanent magnets in an outer circumferential surface direction of the rotor core so that a magnetic flux that causes demagnetization to the plurality of permanent magnets is blocked.

### CROSS-REFERENCE TO RELATED APPLICATION AND CLAIM OF PRIORITY

This application claims the priority benefit of Korean Patent Application No. 10-2015-0041336, filed on Mar. 25, 2015 in the Korean Intellectual Property Office, the disclosure of which is incorporated herein by reference.

### FIELD

Embodiments of the present disclosure relate to a rotor in which a plurality of permanent magnets are buried along a circumference thereof, a motor including the same, and a method of manufacturing the same.

### BACKGROUND

A motor, which is a machine that obtains rotary power from electric energy, may include a stator and a rotor. The rotor is configured to interact with the stator electromagnetically, and may be rotated by force applied between a magnetic field and a current flowing through a coil.

Particularly, a permanent magnet synchronous motor has a high efficiency and a high durability, and thus has been used in various fields such as home appliances, electric vehicles, and industrial equipment, and the like.

The permanent magnet synchronous motor may be divided into a surface mounted permanent magnet synchronous motor (SPMSM) in which a magnet is attached to a surface of a rotor and an interior buried permanent magnet synchronous motor (IPMSM) in which the magnet is buried in the rotor according to a magnet combination type.

In the IPMSM, the magnet is disposed inside the rotor, so that the magnet may be prevented from being separated from the rotor by centrifugal force. Therefore, the IPMSM may be driven even at a high velocity which is a constant power range.

### SUMMARY

Therefore, it is an aspect of the present disclosure to provide a rotor including a demagnetization prevention barrier for preventing demagnetization of a permanent magnet which is buried along a circumference thereof, a motor including the same, and a method of manufacturing the same.

In accordance with one aspect of the present disclosure, a rotor includes a rotor core provided to be rotatable by attraction and repulsion applied from an outside, a plurality of permanent magnets buried along a circumference of the rotor core to extend in a different direction from a radial direction of the rotor core, and a plurality of demagnetization prevention barriers installed to be spaced apart from both ends of each of the plurality of permanent magnets in a direction toward an outer circumferential surface of the rotor core so that a magnetic flux that causes demagnetization to the plurality of permanent magnets is blocked.

Further, each of the plurality of permanent magnets may extend in a direction perpendicular to the radial direction of the rotor core.

Further, each of the plurality of permanent magnets may include a first surface perpendicular to the radial direction of the rotor core and facing an inside of the rotor core, a second surface perpendicular to the radial direction of the rotor core and facing an outside of the rotor core, and a third surface which connects the first surface to the second surface.

Further, each of the plurality of demagnetization prevention barriers may be installed to be spaced apart from both ends of the first surface in the direction toward the outer circumferential surface of the rotor core.

Further, each of the plurality of demagnetization prevention barriers may be installed at a position corresponding to a demagnetization region of the both ends of the first surface.

Further, each of the plurality of permanent magnets may be buried in a shape having a bent protruding toward a rotation axis of the rotor core.

Further, the rotor core may include a plurality of outer cores divided by each of the plurality of permanent magnets in the radial direction of the rotor core, and each of the plurality of permanent magnets may include a fourth surface adjacent to the plurality of outer cores, a fifth surface opposite to the fourth surface, and a sixth surface which connects the fourth surface to the fifth surface.

Further, each of the plurality of demagnetization prevention barriers may be installed to be spaced apart from both ends of the fourth surface in the direction toward the outer circumferential surface of the rotor core.

Further, each of the plurality of demagnetization prevention barriers may be installed at a position corresponding to a demagnetization region of the both ends of the fourth surface.

Further, each of the plurality of demagnetization prevention barriers may be implemented as at least one of an air hole and non-magnetic material.

Further, each of the plurality of demagnetization prevention barriers may be provided to have a chamfered corner.

In accordance with another aspect of the present disclosure, a motor includes a stator including a plurality of teeth magnetized by a plurality of coils and a rotor inserted in the stator to be rotatable by attraction and repulsion applied from the magnetized teeth, and the rotor includes a rotor core provided to be rotatable by the stator, a plurality of permanent magnets buried along a circumference of the rotor core to extend in a different direction from a radial direction of the rotor core, and a plurality of demagnetization prevention barriers installed to be spaced apart from both ends of each of the plurality of permanent magnets in a direction toward an outer circumferential surface of the rotor core so that a magnetic flux that causes demagnetization to the plurality of permanent magnets is blocked.

Further, each of the plurality of permanent magnets may extend in a direction perpendicular to the radial direction of the rotor core.

Further, each of the plurality of permanent magnets may include a first surface perpendicular to the radial direction of the rotor core and facing an inside of the rotor core, a second surface perpendicular to the radial direction of the rotor core and facing an outside of the rotor core, and a third surface which connects the first surface to the second surface.

Further, each of the plurality of demagnetization prevention barriers may be installed to be spaced apart from both ends of the first surface in the direction toward the outer circumferential surface of the rotor core.

Further, each of the plurality of demagnetization prevention barriers may be installed at a position corresponding to a demagnetization region of the both ends of the first surface.

Further, each of the plurality of permanent magnets may be buried in a shape having a bent protruding toward a rotation axis of the rotor core.

Further, the rotor core may include a plurality of outer cores divided by each of the plurality of permanent magnets in the radial direction of the rotor core, and each of the plurality of permanent magnets may include a fourth surface adjacent to the plurality of outer cores, a fifth surface opposite to the fourth surface, and a sixth surface which connects the fourth surface to the fifth surface.

Further, each of the plurality of demagnetization prevention barriers may be installed to be spaced apart from both ends of the fourth surface in the outer circumferential surface direction of the rotor core.

Further, each of the plurality of demagnetization prevention barriers may be installed a position corresponding to a demagnetization region of the both ends of the fourth surface.

Further, each of the plurality of demagnetization prevention barriers may be implemented as at least one of an air hole and a non-magnetic material.

Further, each of the plurality of demagnetization prevention barriers may be provided to have a chamfered corner.

In accordance with still another aspect of the present disclosure, a method of manufacturing a motor including a stator having a plurality of teeth magnetized by a plurality of coils and a rotor including a rotor core which is rotatable by attraction and repulsion applied from the magnetized teeth, the method includes burying a plurality of permanent magnets which extend in a different direction from a radial direction of the rotor core along a circumference of the rotor core, determining whether a torque of the motor is equal to or greater than a target torque, installing a plurality of demagnetization prevention barriers to be spaced apart from both ends of each of the plurality of permanent magnets in a direction toward an outer circumferential surface of the rotor core when the torque of the motor is equal to or greater than the target torque, and reducing a thickness of each of the plurality of permanent magnets so that the torque of the motor is matched to the target torque.

Further, the installing of the plurality of demagnetization prevention barriers may include determining a demagnetization region of each of the plurality of permanent magnets and installing the plurality of demagnetization prevention barriers at a position in which an area of the demagnetization region is reduced equal to or smaller than a predetermined area.

Further, the method may further include extending each of the plurality of permanent magnets by a length corresponding to the reduced thickness when the torque of the motor is matched to the target torque.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating an axial section of a motor in accordance with an embodiment of the present disclosure;

FIG. 2 is a view illustrating a horizontal section of the motor in accordance with the embodiment of the present disclosure;

FIG. 3 is a view illustrating a horizontal section of a rotor in accordance with the embodiment of the present disclosure;

FIG. 4 is a view illustrating a horizontal section of a rotor core in accordance with the embodiment of the present disclosure;

FIG. 5 is a view for describing an operation of a demagnetization prevention barrier in accordance with the embodiment of the present disclosure;

FIG. 6 is a view illustrating various shapes of the demagnetization prevention barrier in accordance with the embodiment of the present disclosure;

FIG. 7 is a view for describing a method of installing the demagnetization prevention barrier in accordance with the embodiment of the present disclosure;

FIG. 8 is a view illustrating a horizontal section of a motor in accordance with another embodiment of the present disclosure;

FIG. 9 is a view illustrating a horizontal section of a rotor in accordance with the other embodiment of the present disclosure;

FIG. 10 is a view illustrating a horizontal section of a rotor core in accordance with the other embodiment of the present disclosure;

FIG. 11 is a view for describing an operation of a demagnetization prevention barrier in accordance with the other embodiment of the present disclosure;

FIG. 12 is a view illustrating various shapes of the demagnetization prevention barrier in accordance with the other embodiment of the present disclosure;

FIG. 13 is a view for describing a method of installing the demagnetization prevention barrier in accordance with the other embodiment of the present disclosure;

FIG. 14 is a flowchart showing a method of manufacturing a motor in accordance with an embodiment of the present disclosure; and

FIG. 15 is a flowchart showing a method of manufacturing a motor in accordance with another embodiment of the present disclosure.

### DETAILED DESCRIPTION

Hereinafter, embodiments of a rotor and a motor including the same will be described in detail with reference to the accompanying drawings.

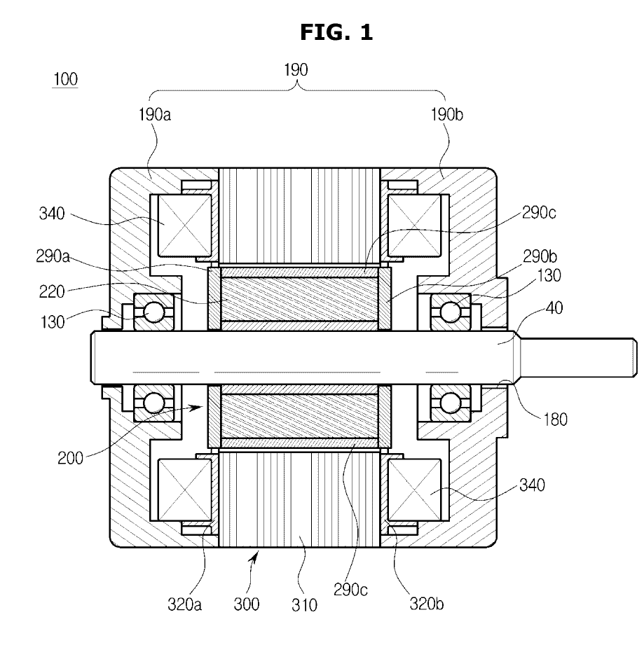

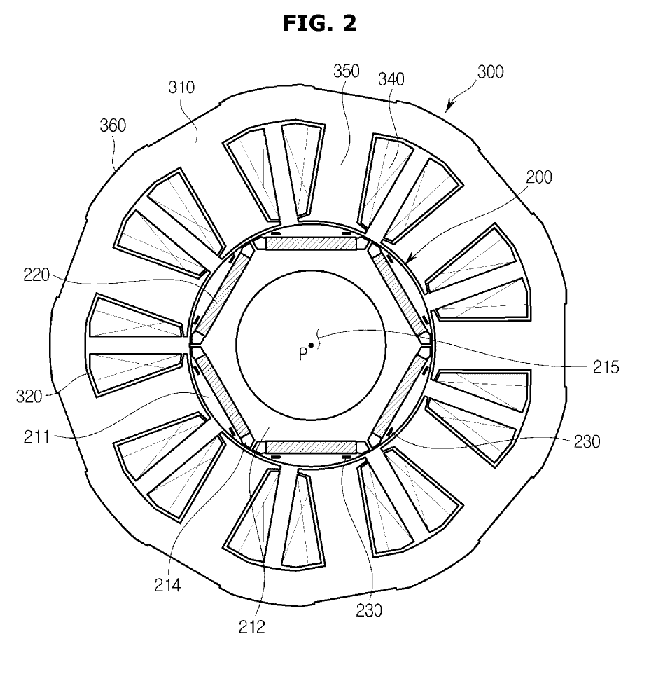

An embodiment of a motor including a rotor will be described with reference to FIGS. 1 and 2.

FIG. 1 illustrates an axial section of the motor in accordance with the embodiment, and FIG. 2 illustrates a horizontal section of the motor in accordance with the embodiment.

A motor 100 may include a motor housing 190, a stator 300, a shaft 40, and a rotor 200.

The motor housing 190 forms an exterior of the motor 100, and provides fixation power by being combined to fixing protrusions 360 of the stator 300 so that the stator 300 is not rotated.

Further, the motor housing 190 may be divided into a first motor housing 190a and a second motor housing 190b based on a horizontal axis. The first motor housing 190a and the second motor housing 190b may be connected to the stator 300.

The stator 300 may include a stator core 310, teeth 350, coils 340, insulators 320, and the fixing protrusions 360.

The stator core 310 may maintain a shape of the stator 300 by forming a frame of the stator 300, and provide a path in which a magnetic field is formed so that when one tooth 350 is magnetized with a polarity by a power, another tooth 350 adjacent to the one tooth 350 is induced and magnetized with a polarity different from the polarity of the one tooth 350.

Further, the stator core 310 may be formed to have a cylindrical shape, by stacking press-processed iron plates. Further, the plurality of teeth 350 may be disposed inside the stator core 310 in a circumferential direction, and the plurality of fixing protrusions 360 may be disposed at an outer side of the stator core 310. In addition, various shapes for maintaining the shape of the stator 300 and ensuring the disposition of the teeth 350 and the fixing protrusion 360 may be used as an example of a shape of the stator core 310.

Further, a plurality of first insertion holes may be formed in the stator core 310 to pass through the stator core 310 in an axial direction of the stator core 310. Further, fastening members such as pins, rivets, bolts, or the like for combining respective plates constituting the stator core 310 may be inserted into the first insertion hole.

First insertion protrusions may be formed in the first motor housing 190a and the second motor housing 190b to be combined with the first insertion holes of the stator core 310 in male and female combination such that the first motor housing 190a may be connected to the stator 300, and the second motor housing 190b may be connected to the stator 300. Housing through-holes may be formed in the first motor housing 190a and the second motor housing 190b to correspond to the first insertion holes of the stator core 310 such that the first motor housing 190a, the second motor housing 190b, and the stator 300 may be connected to each other by a single fastening member.

The plurality of teeth 350 may be disposed inside the stator core 310 such that a space in the stator core 310 is divided into a plurality of slots along a circumferential direction. Further, the teeth 350 may provide a space in which the coils 340 are disposed, and may be magnetized with one of N pole and S pole by a magnetic field formed due to power supplied to the coils 340.

Further, the teeth 350 may have a Y shape, and an outer surface adjacent to the rotor 200 among outer surfaces of the teeth 350 may have a curved surface in order to generate efficiently attraction and repulsion with respect to an outer core 211 in the rotor 200. In addition, various structures for providing the space in which the coils 340 are disposed and efficiently generating the attraction and repulsion with respect to the outer core 211 may be used as an example of the teeth 350.

The coils 340 may be disposed in the insulators 320 disposed on the teeth 350 of the stator 300 to form a magnetic field due to the supplied power. Therefore, the coil 340 may magnetize the tooth 350 on which the corresponding coil 340 is disposed.

Further, the power supplied to the coils 340 may be a three-phase power or a single-phase power.

For example, when the power supplied to the coils 340 is the three-phase power, U-phase power may be supplied by grouping three pairs of coils 340 illustrated in FIG. 2, V-phase power may be supplied by grouping another three pairs of coils 340, and W-phase power may be supplied by grouping the other three pairs of coils 340.

In addition, various combinations of the coils 340 for controlling the rotation of the rotor 200 and efficiently operating the attraction and repulsion between magnetic fields of the rotor 200 and the stator 300 may be used as an example of the combinations of the coils 340.

Further, a method of winding the coil 340 may include a concentrated winding method and a distributed winding method. The concentrated winding method is a method of winding the coils 340 so that the number of slots per one pole per phase is 1 in the stator 300, and the distributed winding method is a method of winding the coils 340 in which the coils 340 are wound to be distributed in two slots or more in an electric device to which slots are attached. In addition, various methods for efficiently magnetizing the teeth 350 may be used as an example of the method of winding the coil 340.

Finally, material used for the coil 340 may be copper, aluminum, or composite material of copper and aluminum. In addition, various materials for efficiently magnetizing the teeth 350 may be used as an example of the material of the coil 340.

The insulator 320 is an insulating member for preventing an electromagnetic and conductive material of the stator 300 from being in contact with the coil 340 and being conductive, and may be divided into a first insulator 320a and a second insulator 320b.

The first insulator 320a and the second insulator 320b each are formed of material having electrical insulation properties, and are respectively disposed at both sides of the stator core 310 with respect to the axial direction. The first insulator 320a and the second insulator 320b are respectively combined with the both sides of the stator core 310 to cover the stator 300.

Further, second insertion protrusions protruding toward the stator core 310 may be formed in the first insulator 320a and the second insulator 320b, and inserted in second insertion holes formed in the stator core 310.

Each of the first insulator 320a and the second insulator 320b may include a ring-shaped rim, a plurality of coil supports arranged corresponding to the stator core 310, and a coil guide unit protruding from insides and outsides of the coil supports in a radial direction.

Further, the coil supports may be spaced apart from each other in a circumferential direction, and thus spaces corresponding to slots of the stator 300 may be formed between the coil supports.

The fixing protrusion 360 may provide fixation power so that the stator 300 is not rotated in the second motor housing 190b to be fixed despite rotary power caused by repulsion and attraction between a magnetic field formed by power supplied to the coils 340 and a magnetic field formed by permanent magnets 220.

Further, the fixing protrusions 360 may be formed perpendicular or parallel to the shaft 40 at outer partition walls of the stator core 310 so as to be combined with grooves of the motor housing 190 in a male and female combination. In addition, various forms for fixing the stator 300 to the motor housing 190 may be used as an example of the fixing protrusions 360.

The shaft 40 may be connected to a shaft insertion hole 215 of the rotor 200 to be rotated with the rotor 200. One side of the shaft 40 may be supported rotatably by the second motor housing 190b through bearings 130, and the other side of the shaft 40 may be supported rotatably by the first motor housing 190a through the bearings 130. Further, the one side of the shaft 40 supported by the second motor housing 190b may protrude toward the outside of the motor housing 190 through openings 180 formed in the second motor housing 190b, and may be connected to an apparatus which requires driving force.

The rotor 200, which is an apparatus for obtaining rotary power of the motor 100 by applying the attraction and repulsion between a magnetic field by the permanent magnet 220 and a magnetic field formed in the teeth 350 of the stator 300, may be disposed inside the stator 300. A first rotor housing 290a and a second rotor housing 290b may be provided on traverse sides of the rotor 200, and a third rotor housing 290c may be provided on a longitudinal side of the rotor 200. The rotor 200 may include a rotor core 210 and the permanent magnets 220.

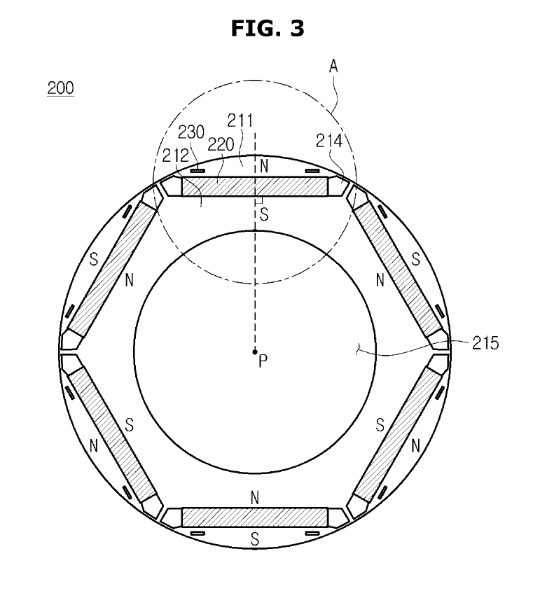

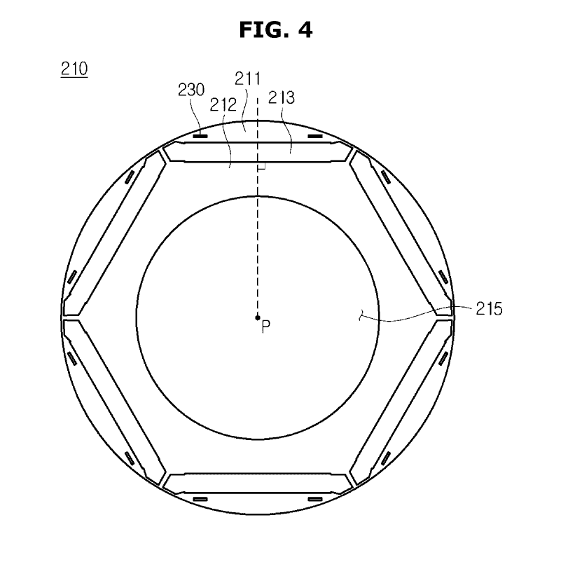

The rotor 200 will be described in detail with reference to FIGS. 3 and 4 to be illustrated below.

Hereinafter, an embodiment of the rotor will be described with reference to FIGS. 3 and 4.

FIG. 3 illustrates a horizontal section of the rotor in accordance with the embodiment, and FIG. 4 illustrates a horizontal section of the rotor core in accordance with the embodiment.

The rotor 200 may include the rotor core 210 for concentrating a path and a magnetic flux of the magnetic field formed by the permanent magnets 220 and preventing scattering, the permanent magnets 220 for forming a magnetic field, and demagnetization prevention barriers 230 for preventing the demagnetization of the permanent magnets 220.

The rotor core 210 may include an inner core 212, the outer core 211, magnetic flux leakage prevention units 214, and permanent magnet mounting units 213.

The permanent magnet mounting units 213 are disposed along a circumference of the rotor core 210, and provide spaces in which the permanent magnets 220 are magnetized.

Specifically, the permanent magnet mounting units 213 may be disposed so that the rotor core 210 is divided into the inner core 212 and the outer core 211 as illustrated in FIG. 4. The inner core 212 may be an area radially inside, that is, an area adjacent to a rotation axis P between areas divided by the permanent magnet mounting units 213, and the outer core 211 may be an area radially outside, that is, an area distant from the rotation axis P between the areas divided by the permanent magnet mounting units 213.

In the manner, in order to divide the rotor core 210 into the inner core 212 and the outer core 211, the permanent magnet mounting units 213 may be disposed along the circumference of the rotor core 210 so that a length direction of the permanent magnet mounting unit is perpendicular to a radial direction of the rotor core 210.

Further, the permanent magnet mounting units 213 may be disposed symmetrical with respect to the rotation axis of the rotor core 210. A magnetic pole direction of a first one of the permanent magnets 220 magnetized at the permanent magnet mounting unit 213 disposed in this manner may be opposite to a magnetic pole direction of a second one of the permanent magnets 220 adjacent to the first one.

For example, when the permanent magnet 220 is magnetized at a single permanent magnet mounting unit 213 so that an N pole faces the outer core 211 and an S pole faces the inner core 212, the permanent magnets 220 may be magnetized at two adjacent permanent magnet mounting units 213 so that S poles face the outer core 211 and N poles face the inner core 212.

As a result, the same number of N poles and S poles may be alternately formed in the outer core 211.

The rotor 200 and the motor 100, in which the permanent magnets 220 are buried in this manner, are referred to as a bar-type rotor 200 and motor 100. In the bar-type rotor 200, the permanent magnets 220 extend perpendicular to the radial direction of the rotor core 210.

The inner core 212 may have a cylindrical shape and the shaft insertion hole 215 connected to the shaft 40 may be provided therein.

Further, the inner core 212 may make a frame of the rotor 200 so that the shape of the rotor 200 is maintained against stress applied to the rotor 200 during the rotation of the rotor 200. Further, the inner core 212 may serve to flow the magnetic flux along the inner core 212 by providing a path of the magnetic field formed by the permanent magnets 220.

As the magnetic field is formed by the permanent magnet 220, the outer core 211 may provide the stator 300 with a magnetic flux introduced, or may be provided with the magnetic flux from the stator 300.

Materials of the above-described inner core 212 and outer core 211 may include soft magnetic material or metal so as to provide the path in which the magnetic flux flows. In addition, various materials having electromagnetic conductivity and in which the deformation of the shape due to the external stress does not occur may be used when forming the inner core 212 and the outer core 211.

As the magnetic flux leakage prevention units 214 may be disposed at both ends of each of the magnetized permanent magnets 220, leakage of the magnetic flux introduced from and to the permanent magnets 220 is reduced. Specifically, the magnetic flux leakage prevention units 214 may be provided at both sides of each of areas of the permanent magnet mounting units 213 in which the permanent magnets 220 are magnetized, the magnetic flux leakage prevention units 214 may be filled with non-magnetic material such as plastic, air, or the like, and thus the leakage of the magnetic flux formed by the permanent magnets 220 to the inner core 212 is reduced.

The demagnetization prevention barriers 230 are spaced apart from the permanent magnets 220 in a direction toward an outer circumferential surface of the rotor core 210, to prevent demagnetization caused by the stator 300. Here, it is assumed that the demagnetization is local demagnetization occurring at the both ends of the permanent magnet 220 rather than at the entire permanent magnet 220.

Although there are a number of factors of the demagnetization, the demagnetization prevention barriers 230 may block a reverse magnetic flux introduced from the stator 300, to prevent the demagnetization. In this case, the reverse magnetic flux may refer to a magnetic flux of a direction in which the magnetic flux generated during the normal driving of the motor 100 is reduced.

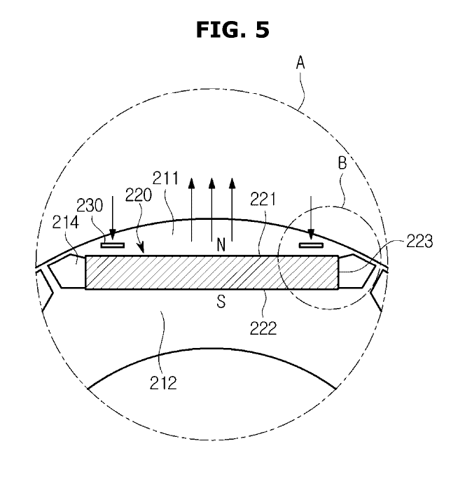

Hereinafter, positions, operations, and shapes of the demagnetization prevention barriers 230 in accordance with the embodiment will be described with reference to FIGS. 5 to 7.

FIG. 5 is a view for describing an operation of a demagnetization prevention barrier in accordance with the embodiment. FIG. 5 is an enlarged view illustrating an area A of FIG. 3, and illustrates one permanent magnet 220 of the plurality of buried permanent magnets 220 in which an N pole faces the outer core 211 and an S pole faces the inner core 212.

In general, a permanent magnet generates a magnetic flux flowing from the N pole to the S pole, and the one permanent magnet 220 of FIG. 5 shown in FIG. 5 discharge the magnetic flux to the stator 300 through the outer core 211. The magnetic flux introduced into the stator 300 may be discharged from the stator 300 and introduced into another permanent magnet (not shown) adjacent to the one permanent magnet 220 of FIG. 5. This is because that the adjacent permanent magnet (not shown) into which the magnetic flux is introduced has the S pole thereof oriented toward the outer core 211. Since the N pole of the adjacent permanent magnet (not shown) is oriented toward the inner core 212, the magnetic flux may be discharged in a direction toward the inner core 212, the magnetic flux may be introduced to the S pole of the one permanent magnet 220 of FIG. 5, thereby completing a magnetic flux path.

When a magnetic flux flowing along the above-described magnetic flux path is referred to as a forward magnetic flux, a magnetic flux applied from the stator 300 to the permanent magnet 220 of FIG. 5 may be referred to as a reverse magnetic flux. When the reverse magnetic flux is introduced the permanent magnet 220 having the N pole face the outer core 211, some of the forward magnetic flux is offset against the introduced reverse magnetic flux, causing demagnetization to a surface of the permanent magnet 220.

Therefore, the demagnetization prevention barrier 230 may prevent the demagnetization from occurring in the permanent magnet 220 by blocking the reverse magnetic flux introduced from the stator 300. To this end, as illustrated in FIG. 5, the demagnetization prevention barriers 230 may be to be spaced apart from the permanent magnet 220 in the outer circumferential surface direction of the rotor core 210.

Specifically, when the permanent magnet 220 is divided into a first surface 221 which is perpendicular to the radial direction of the rotor core 210 and faces an inside of the rotor core 210, a second surface 222 which is perpendicular to the radial direction of the rotor core 210 and faces an outside of the rotor core 210, and a third surface 223 which connects the first surface 221 to the second surface 222, the demagnetization prevention barriers 230 may be installed to be spaced apart from the first surface 221 of the permanent magnet 220 in the direction toward the outer circumferential surface direction of the rotor core 210.

Particularly, since the demagnetization due to the reverse magnetic flux is generated at both ends of the permanent magnet 220, the demagnetization prevention barriers 230 may be installed to be spaced apart from both ends of the first surface 221 in the outer circumferential surface direction of the rotor core 210. As a result, two demagnetization prevention barriers 230 may be installed at the both ends of a single permanent magnet 220.

The demagnetization prevention barrier 230 may be implemented on the outer core 211 of the rotor core 210 in the form of an air hole. Alternatively, the demagnetization prevention barrier 230 may also be implemented of non-magnetic material such as plastic. As such, the demagnetization prevention barrier 230 may be implemented in various methods within the technological scope in which the reverse magnetic flux is blocked from being introduced into the permanent magnet 220.

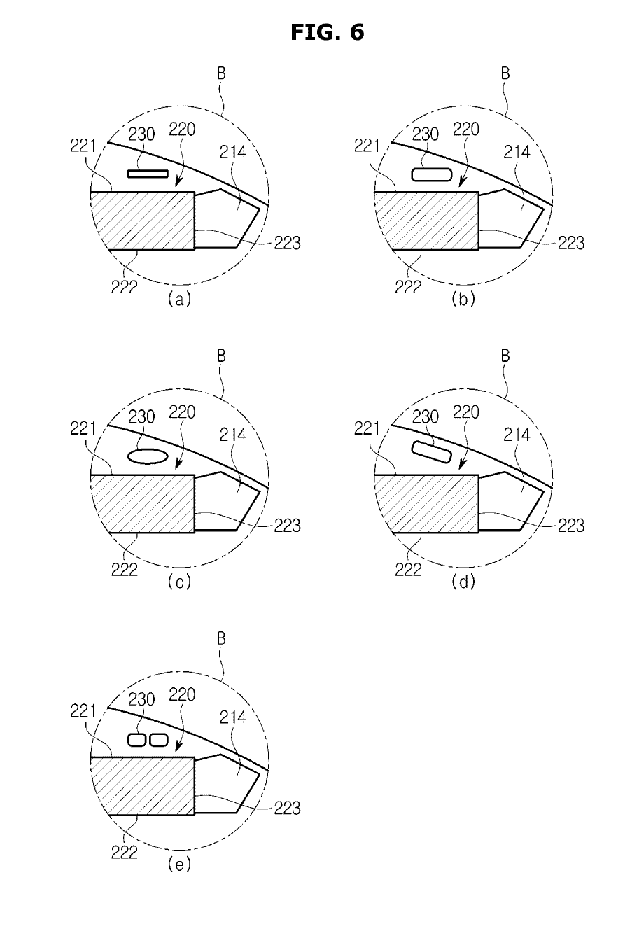

FIG. 6 is a view illustrating various shapes of the demagnetization prevention barrier in accordance with the embodiment. FIG. 6 is an enlarged view illustrating an area B of FIG. 5.

Drawings (a) to (c) of FIG. 6 illustrate the cases in which the demagnetization prevention barrier 230 is installed parallel to the permanent magnet 220.

The demagnetization prevention barrier 230 may be provided in a rectangular shape extending to be parallel to a length direction of the permanent magnet 220 as illustrated in drawing (a) of FIG. 6. As described above, air or non-magnetic material may be introduced into the demagnetization prevention barrier 230.

As illustrated in drawing (b) of FIG. 6, the demagnetization prevention barrier 230 may be installed by chamfering corners of a rectangle parallel to the length direction of the permanent magnet 220. When the corners of the demagnetization prevention barrier 230 are chamfered, the progress of the forward magnetic flux discharged from the permanent magnet 220 may not be disturbed.

As illustrated in drawing (c) of FIG. 6, the demagnetization prevention barrier 230 may be installed to have an ellipse shape parallel to the length direction of the permanent magnet 220.

As such, the demagnetization prevention barrier 230 may be installed in various shapes while being parallel to the permanent magnet 220.

Alternatively, the demagnetization prevention barrier 230 may be installed to be tilted by a predetermined angle with respect to the permanent magnet 220.

Drawing (d) of FIG. 6 illustrates the case in which the demagnetization prevention barrier 230 having a rectangular shape with corners thereof chamfered is installed to be tilted by a predetermined angle with respect to the length direction of the permanent magnet 220.

Thus, since the demagnetization prevention barrier 230 may be installed to be tilted from the permanent magnet 220, it may be preferable to install the demagnetization prevention barrier 230 at a position in which the demagnetization of the permanent magnet 220 may be reduced.

Until now, the case in which a single demagnetization prevention barrier 230 is installed to be spaced apart from an end of the first surface 221 of the permanent magnet 220 has been described. Alternatively, the plurality of demagnetization prevention barriers 230 may be installed to be spaced apart from one end of the first surface 221 of the permanent magnet 220.

Drawing (e) of FIG. 6 illustrates the case in which two demagnetization prevention barriers 230 are installed to be spaced apart from one end of the first surface 221. Since the number of the demagnetization prevention barriers 230 installed in this manner is not limited, it may be preferable to install the demagnetization prevention barriers 230 in a predetermined number in which the demagnetization of the permanent magnet 220 may be reduced.

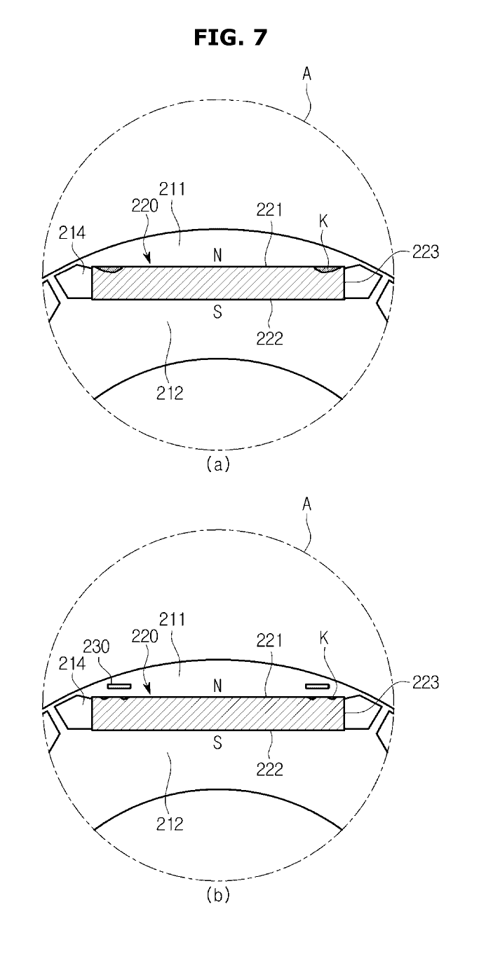

FIG. 7 is a view for describing a method of installing the demagnetization prevention barrier in accordance with the embodiment. FIG. 7 is an enlarged view illustrating an area C of FIG. 3.

In order to install the demagnetization prevention barrier 230, first, the permanent magnet 220 may be buried in the rotor core 210. Next, a demagnetization region of the buried permanent magnet 220 may be determined. In drawing (a) of FIG. 7, areas K, which represent demagnetization regions, show that the occurrence of the demagnetization begins from both ends of the permanent magnet 220.

After the demagnetization regions are determined, the demagnetization prevention barrier 230 may be installed to be spaced apart at a position corresponding to the demagnetization region of the first surface 221 of the permanent magnet 220. Since the demagnetization of (a) of FIG. 7 is caused by the introduction of the reverse magnetic flux, the demagnetization prevention barrier 230 may be installed at a position in which the progress of the reverse magnetic flux may be blocked between an outer circumferential surface of the rotor 200 and the first surface 221 of the permanent magnet 220.

Accordingly, the demagnetization regions may be reduced as illustrated in drawing (b) of FIG. 7. Thus, the output of the motor 100 is prevented from being decreased, the reliability with respect to the performance of the motor 100 is increased, and the lifespan of the motor 100 may also extend.

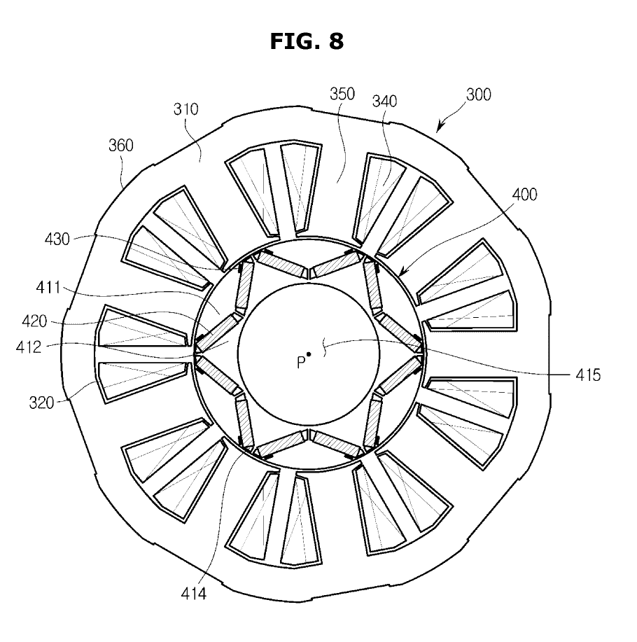

Until now, as an assumption, the case in which the plurality of permanent magnets 220 are installed in the rotor 200 to extend in a direction perpendicular to the radial direction of the rotor core 210 has been described. Hereinafter, as an assumption, the case in which the plurality of permanent magnets 420 are provided in a rotor 400 while having bents protruding in a direction toward the rotation axis P and are buried in a rotor core 410 will be described with reference to FIGS. 8 to 13.

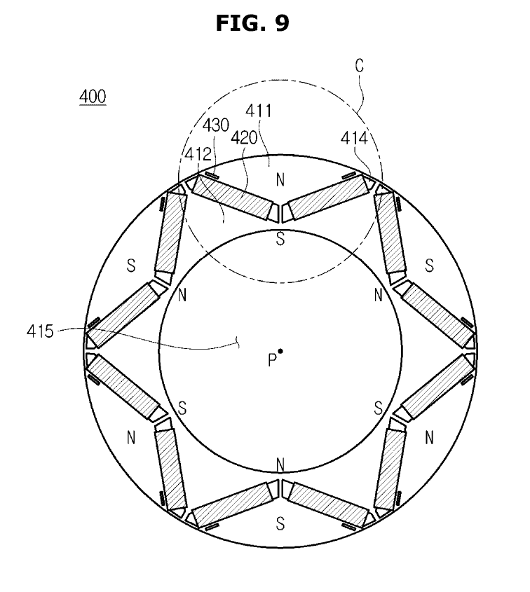

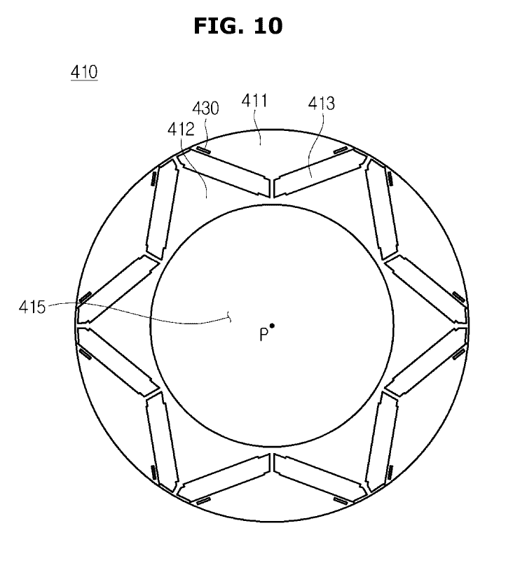

FIG. 8 is a view illustrating a horizontal section of a motor in accordance with another embodiment, FIG. 9 is a view illustrating a horizontal section of a rotor in accordance with the other embodiment, and FIG. 10 is a view illustrating a horizontal section of a rotor core in accordance with the other embodiment.

Referring to FIG. 8, the rotor 400 in accordance with the other embodiment may be inserted in the same stator 300 as described in FIG. 2.

The rotor 400 of FIGS. 9 and 10 includes the rotor core 410, permanent magnets 420, and demagnetization prevention barriers 430 as the same as the rotor 200 of FIGS. 3 and 4.

Further, the rotor core 410 of FIGS. 9 and 10 includes an inner core 412, an outer core 411, magnetic flux leakage prevention units 414, and permanent magnet mounting units 413 as the same as the rotor core 210 of FIGS. 3 and 4.

The permanent magnet mounting units 413 may be disposed along a circumference of the rotor core 410 to provide spaces in which the permanent magnets 420 are magnetized, and specifically, to divide the rotor core 410 into the inner core 412 and the outer core 411 as illustrated in FIG. 9. In this case, the inner core 412 may be an area radially inside, that is, an area adjacent to a rotation axis P between areas divided by the permanent magnet mounting units 413, and the outer core 411 may be an area radially outside between the areas divided by the permanent magnet mounting units 413.

In order to divide the rotor core 410 into the inner core 412 and the outer core 411 as the above, the permanent magnet mounting units 413 may be disposed along the circumference of the rotor core 410 in a shape which has bents protruding in the direction toward the rotation axis P.

Further, the permanent magnet mounting units 413 may be disposed symmetrical with respect to the rotation axis P of the rotor core 410. A magnetic pole direction of a first one of the permanent magnets 420 magnetized to the permanent magnet mounting units 413 disposed in this manner may be opposite to a magnetic pole direction of a second one of the permanent magnets 420 adjacent to the first one.

For example, when the permanent magnet 420 is magnetized at a single permanent magnet mounting unit 413 so that an N pole faces the outer core 411 and an S pole faces the inner core 412, the permanent magnets 420 may be magnetized at two adjacent permanent magnet mounting units 413 so that S poles face the outer core 411 and N poles face the inner core 412.

As a result, the same number of N poles and S poles may be alternately formed in the outer core 411, and thus, the rotary power may be received from the stator 300.

The rotor 400 and the motor 100, in which the permanent magnets 420 are buried in this manner, are referred to as a V-type rotor 400 and motor 100. In the V-type rotor 400, since the permanent magnet 420 extends in a direction perpendicular to the radial direction of the rotor core while having a bent in the middle thereof, and thus extends in a different direction from the radial direction of the rotor core 410.

Since the inner core 412 and the outer core 411 of FIGS. 9 and 10 are the same as those described in FIGS. 3 and 4, detailed description thereof is omitted.

As the magnetic flux leakage prevention units 414 are disposed at both ends of each of the magnetized permanent magnets 420, it is possible to reduce leakage of the magnetic flux introduced from and to the permanent magnets 420. Further, as illustrated in FIG. 9, the magnetic flux leakage prevention units 414 are also provided in areas corresponding to the bents of the permanent magnets 420 such that the permanent magnets 420 may be buried discontinuously.

Since the magnetic flux leakage prevention units 414 are the same as those described in FIGS. 3 and 4, detailed description thereof is omitted.

The demagnetization prevention barriers 430 may be spaced apart from the permanent magnets 420 in the direction toward the outer circumferential surface of the rotor core 410. As a result, local demagnetization may be prevented from occurring at both ends of each of the permanent magnets 420 by blocking a reverse magnetic flux introduced from the stator 300.

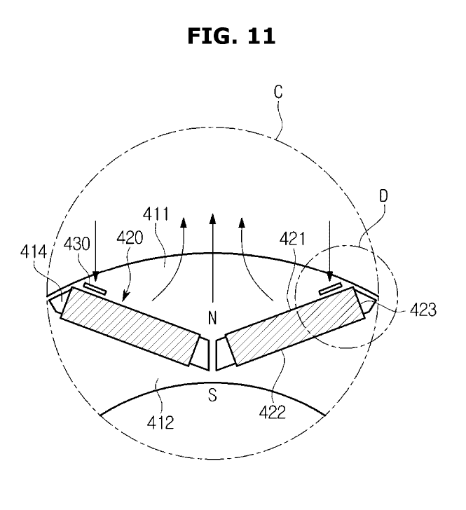

Hereinafter, positions, operations, and shapes of the demagnetization prevention barriers 430 in accordance with the other embodiment will be described with reference to FIGS. 11 to 13.

FIG. 11 is a view for describing an operation of the demagnetization prevention barrier in accordance with the other embodiment. FIG. 11 is an enlarged view illustrating an area C of FIG. 9, and illustrates a single permanent magnet 420 of the plurality of buried permanent magnets 420 in which an N pole faces the outer core 411 and an S pole faces the inner core 412.

The V-type motor 100 also has a flow of the magnetic flux in the same manner as the bar-type motor 100. Referring to FIG. 11, the permanent magnets 420 may discharge the magnetic flux to the stator 300 through the outer core 411. While the discharged magnetic flux progresses through the stator 300, the discharged magnetic flux is introduced into another permanent magnet 420 adjacent to the permanent magnet 420 of FIG. 11, is introduced again into the permanent magnet 420 of FIG. 11 through the inner core 412, and thus a magnetic flux path may be completed.

In the V-type motor 100, since the permanent magnet 420 has bents protruding in the direction toward the rotation axis P, the magnetic flux may be further concentrated at the outer core 411. As a result, the output of the motor 100 may be further improved.

In this case, in the same manner as the bar-type motor 100, the reverse magnetic flux may be introduced into the permanent magnet 420 of the V-type motor 100 from the stator 300. As a result, the demagnetization may occur at both ends of the permanent magnet 420.

As the demagnetization prevention barriers 430 are spaced apart from the permanent magnet 420 in the direction toward the outer circumferential surface of the rotor core 410 as illustrated in FIG. 11, the demagnetization may be prevented from occurring in the permanent magnet 420 by blocking the reverse magnetic flux.

Specifically, when the permanent magnet 420 is divided into a fourth surface 421 adjacent to the outer core 411, a fifth surface 422 opposite to the fourth surface 421, and a sixth surface 423 which connects the fourth surface 421 to the fifth surface 422, the demagnetization prevention barrier 430 may be spaced apart from the fourth surface 421 of the permanent magnet 420 in the direction toward the outer circumferential surface of the rotor core 410.

Particularly, since the demagnetization due to the reverse magnetic flux is generated from both ends of the permanent magnet 420, the demagnetization prevention barrier 430 may be spaced apart from both ends of the fourth surface 421 in the direction toward the outer circumferential surface of the rotor core 410. As a result, two demagnetization prevention barriers 430 may be installed at the both ends of one permanent magnet 420.

The demagnetization prevention barrier 430 may be implemented in various methods within the technological scope in which the reverse magnetic flux is blocked from being introduced into the permanent magnet 420 as described in FIG. 5.

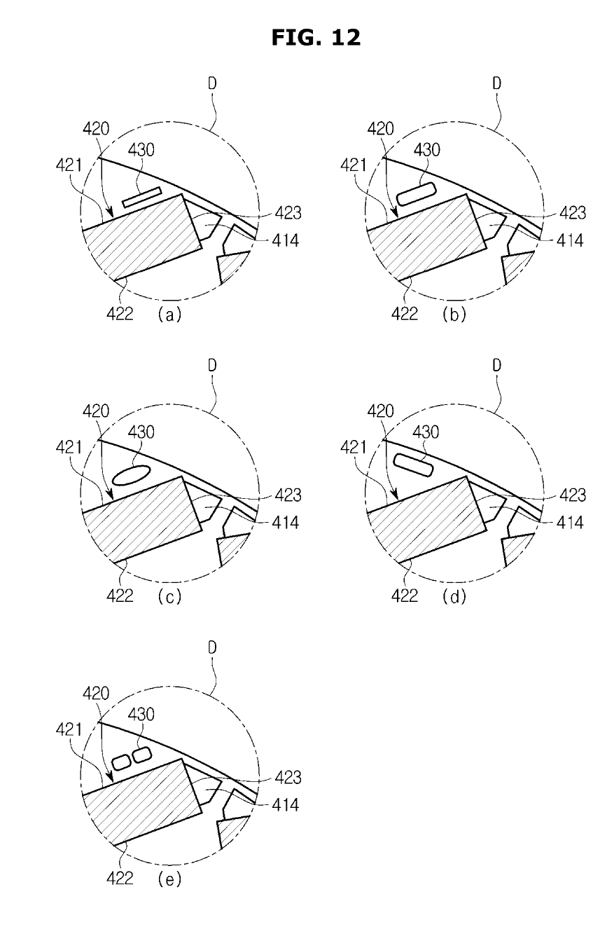

FIG. 12 is a view illustrating various shapes of the demagnetization prevention barrier in accordance with the other embodiment. FIG. 12 is an enlarged view illustrating an area D of FIG. 11.

Drawings (a) to (c) of FIG. 12 illustrate the cases in which the demagnetization prevention barrier 430 is installed parallel to the permanent magnet 420.

The demagnetization prevention barrier 430 may be provided in a rectangular shape extending to be parallel to a length direction of the permanent magnet 420 as illustrated in drawing (a) of FIG. 12. As described above, air or non-magnetic material may be introduced into the demagnetization prevention barrier 430, and thus the reverse magnetic flux may be blocked.

Alternatively, as illustrated in drawing (b) of FIG. 12, the demagnetization prevention barrier 430 may be installed by chamfering corners of a rectangle parallel to the length direction of the permanent magnet 420. When the corners of the demagnetization prevention barrier 430 are chamfered, the forward magnetic flux discharged from the permanent magnet 420 may be prevented from being blocked by the demagnetization prevention barrier 430.

Alternatively, as illustrated in drawing (c) of FIG. 12, the demagnetization prevention barrier 430 may have an ellipse shape parallel to the length direction of the permanent magnet 420.

Thus, the demagnetization prevention barrier 430 may be installed in various shapes while being parallel to the permanent magnet 420.

Alternatively, the demagnetization prevention barrier 430 may be installed to be tilted by a predetermined angle with respect to the permanent magnet 420.

Drawing (d) of FIG. 12 illustrates the case in which the demagnetization prevention barrier 430 having a rectangular shape and of which corners are chamfered is installed to be tilted by a predetermined angle with respect to the length direction of the permanent magnet 420.

Since the demagnetization prevention barrier 430 may be installed to be tilted from the permanent magnet 420, it may be preferable to install the demagnetization prevention barrier 430 at a position in which the demagnetization of the permanent magnet 420 may be reduced.

Until now, the case in which a single demagnetization prevention barrier 430 is installed to be spaced apart from one end of the fourth surface 421 of the permanent magnet 420 has been described. Alternatively, a plurality of the demagnetization prevention barriers 430 may be installed to be spaced apart from one end of the fourth surface 421 of the permanent magnet 420.

Drawing (e) of FIG. 12 illustrates the case in which two demagnetization prevention barriers 430 are installed to be spaced apart from one end of the fourth surface 421. Since the number of the demagnetization prevention barriers 430 installed in this manner is not limited, it may be preferable to install the demagnetization prevention barriers 430 in a predetermined number in which the demagnetization of the permanent magnet 420 may be reduced.

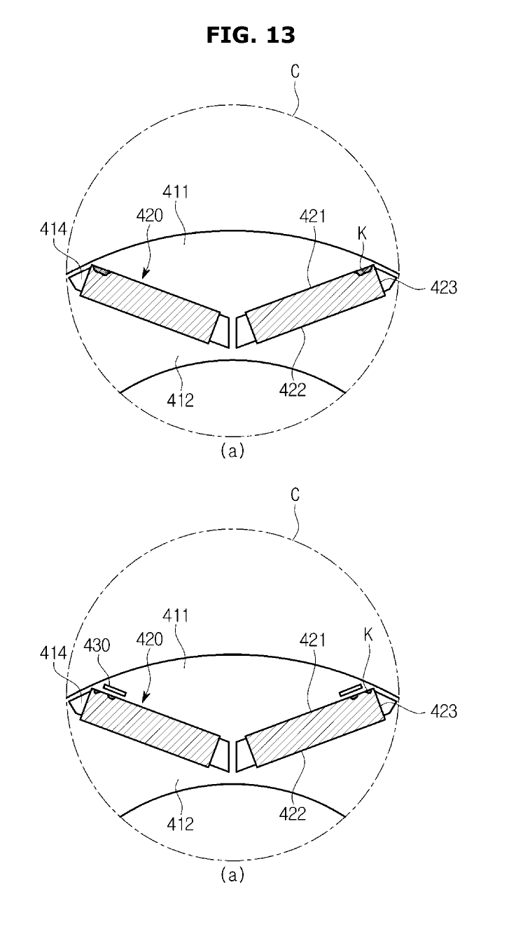

FIG. 13 is a view for describing a method of installing the demagnetization prevention barrier in accordance with the other embodiment. FIG. 12 is an enlarged view illustrating an area C of FIG. 9.

In order to install the demagnetization prevention barrier 430, first, the permanent magnets 420 may be buried in the rotor core 410. Next, demagnetization regions of the buried permanent magnets 420 may be determined. In In drawing (a) of FIG. 13, areas K, which represent demagnetization regions, show that occurrence of the demagnetization begins from both ends of the permanent magnet 420.

After the demagnetization region is determined, the demagnetization prevention barrier 430 may be installed to be spaced apart at a position corresponding to the demagnetization region of the fourth surface 421 of the permanent magnet 420. Since the demagnetization of drawing (a) of FIG. 13 is caused by the introduction of the reverse magnetic flux, the demagnetization prevention barrier 430 may be installed at a position in which the progress of the reverse magnetic flux may be blocked between an outer circumferential surface of the rotor 400 and the fourth surface 421 of the permanent magnet 420.

Accordingly, the demagnetization region may be reduced as illustrated in drawing (b) of FIG. 13. Thus, the output of the motor 100 is prevented from being decreased, the reliability with respect to the performance of the motor 100 is increased, and the lifespan of the motor 100 may also extend.

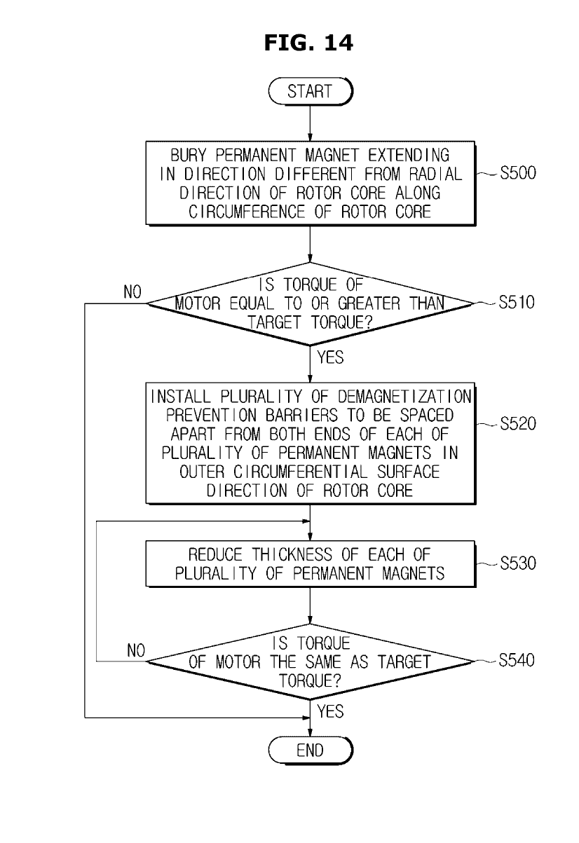

FIG. 14 is a flowchart of a method of manufacturing a motor in accordance with an embodiment.

First, permanent magnets 220 and 420 extending in directions different from radial directions of rotor cores 210 and 410 may be respectively buried along circumferences of the rotor cores 210 and 410 (S500). Since the permanent magnets 220 and 420 extending in the directions different from the radial directions of the rotor cores 210 and 410 are respectively buried in the rotor cores 210 and 410, a motor 100 manufactured by the manufacturing method of FIG. 14 may include a bar-type motor and a V-type motor.

Next, it may be determined whether a torque of the motor 100 is equal to or greater than a target torque (S510). Here, the target torque may refer to a minimum torque of the motor 100 to be manufactured.

When the torque of the motor 100 is smaller than the target torque, the procedure ends, and the manufactured motor 100 may be processed as a defect.

On the other hand, when the torque of the motor 100 is equal to or greater than the target torque, a plurality of demagnetization prevention barriers 230 and 430 may be respectively installed to be spaced apart from both ends of each of a plurality of permanent magnets 220 and 420 in a direction toward the outer circumferential surfaces of the rotor cores 210 and 410 (S520).

Specifically, demagnetization regions of the plurality of permanent magnets 220 and 420 may be respectively determined. When the motor 100 is a bar type, the demagnetization regions of the plurality of permanent magnets 220 and 420 may be determined as illustrated in drawing (a) of FIG. 7. Alternatively, when the motor 100 is a V type, the demagnetization regions of the plurality of permanent magnets 220 and 420 may be determined as in drawing (a) of FIG. 13. As such, local demagnetization may occur at both ends of each of the plurality of permanent magnets 220 and 420.

After the demagnetization region is determined, the demagnetization prevention barriers 230 and 430 may be installed at positions corresponding to the demagnetization regions. Since the demagnetization region is formed by a reverse magnetic flux introduced into the permanent magnets 220 and 420, the demagnetization prevention barriers 230 and 430 may be installed at positions in which the reverse magnetic flux is most blocked among the positions spaced apart from the both ends of each of the plurality of permanent magnets 220 and 420 in the direction toward the outer circumferential surface of the rotor cores 210 and 410.

For example, the demagnetization prevention barriers 230 and 430 may be installed at positions in which an area of the demagnetization region is the minimum among the positions spaced apart from both ends of the permanent magnets 220 and 420 in the direction of the outer circumferential surface of the rotor cores 210 and 410. Alternatively, the demagnetization prevention barriers 230 and 430 may be installed at positions in which the area of the demagnetization region is equal to or smaller than a predetermined area among the positions spaced apart from both ends of the permanent magnets 220 and 420 in the direction of the outer circumferential surface of the rotor cores 210 and 410.

After the demagnetization prevention barriers 230 and 430 are installed, a thickness of each of the plurality of permanent magnets 220 and 420 may be reduced (S530). Next, it is determined whether the torque of the motor 100 is the same as the target torque (S540). When the torque of the motor 100 is different from the target torque, the thickness of each of the plurality of permanent magnets 220 and 420 may be reduced repeatedly. On the other hand, when the torque of the motor 100 reaches the target torque, the procedure ends.

As the demagnetization regions formed in the permanent magnets 220 and 420 are reduced by installing the demagnetization prevention barriers 230 and 430, the thicknesses of the permanent magnets 220 and 420 may be reduced compared to those having the same output. As a result, the manufacturing costs of the motor 100 may be reduced.

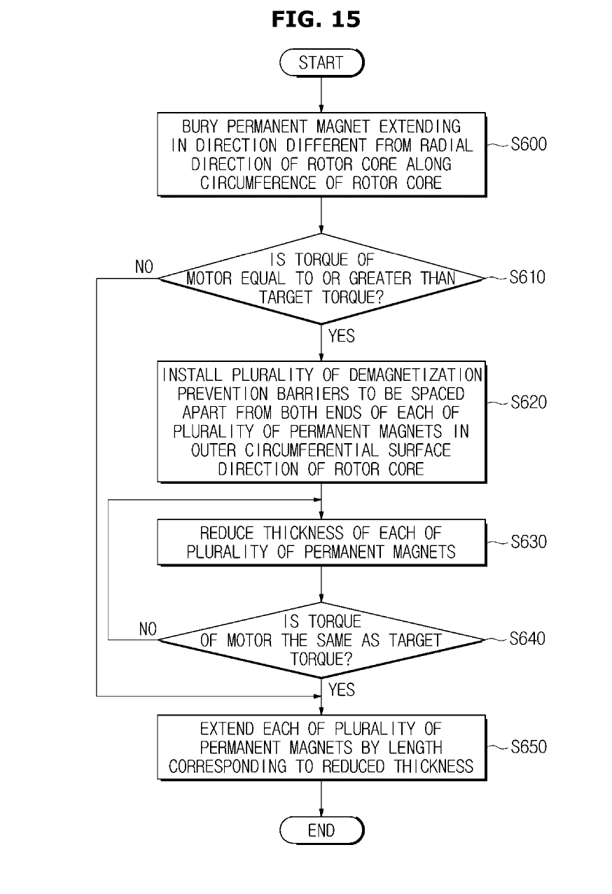

FIG. 15 is a flowchart of a method of manufacturing a motor in accordance with another embodiment.

First, permanent magnets 220 and 420 extending in directions different from radial directions of rotor cores 210 and 410 may be respectively buried along circumferences of the rotor cores 210 and 410 (S600). Since the permanent magnets 220 and 420 extending in the directions different from the radial directions of the rotor cores 210 and 410 are respectively buried in the rotor cores 210 and 410, a motor 100 manufactured by the manufacturing method of FIG. 15 may include a bar-type motor 100 and a V-type motor 100.

Next, it may be determined whether a torque of the motor 100 is equal to or greater than a target torque (S610). Here, the target torque may refer to a minimum torque of the motor 100 to be manufactured.

When the torque of the motor 100 is smaller than the target torque, the procedure ends, and the manufactured motor 100 may be processed as defects.

On the other hand, when the torque of the motor 100 is equal to or greater than the target torque, a plurality of demagnetization prevention barriers 230 and 430 may be respectively installed to be spaced apart from both ends of each of the plurality of permanent magnets 220 and 420 in the direction of the outer circumferential surface of the rotor cores 210 and 410 (S620).

A method of installing the plurality of demagnetization prevention barriers 230 and 430 is the same as that described in FIG. 14.

After the demagnetization prevention barriers 230 and 430 are installed, a thickness of each of the plurality of permanent magnets 220 and 420 may be reduced (S630). Next, it is determined whether the torque of the motor 100 is the same as the target torque (S640). When the torque of the motor 100 is different from the target torque, the thickness of each of the plurality of permanent magnets 220 and 420 may be reduced repeatedly.

On the other hand, when the torque of the motor 100 reaches the target torque, each of the plurality of permanent magnets 220 and 420 may extend by a length corresponding to the reduced thickness (S650). Here, the length corresponding to the reduced thickness indicates that the reduced thickness and the extended length are in a proportional relationship. For example, the quantity of thickness being reduced may be used to extend the lengths of the permanent magnets 220 and 420.

As the demagnetization regions formed in the permanent magnets 220 and 420 are reduced by installing the demagnetization prevention barriers 230 and 430, the motor 100 which outputs an improved torque may be manufactured even with the same buried amount of the permanent magnets 220 and 420.

According to the disclosed rotor and the motor including the same, demagnetization may be prevented from occurring at both ends of each of a plurality of permanent magnets which are buried along a circumference of the rotor. As a result, an output may be prevented from being decreased due to the demagnetization.

Further, it is possible to design a motor with a reduced thickness of each of the plurality of permanent magnets. As a result, the manufacturing costs of the permanent magnets can be reduced.

Further, it is possible to design a motor with the plurality of permanent magnets extended by a length corresponding to the reduced thickness. As a result, it is possible to design a motor having a high output relative to the quantity of buried permanent magnets.

Further, demagnetization may be prevented from occurring in a permanent magnet, and thus the lifespan of the motor can be extended.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A rotor, comprising:
a rotor core provided to be rotatable by attraction and repulsion applied from an outside;
a plurality of permanent magnets buried along a circumference of the rotor core to extend in a different direction from a radial direction of the rotor core; and
a plurality of demagnetization prevention barriers installed to be spaced apart from both ends of each of the plurality of permanent magnets in a direction toward an outer circumferential surface of the rotor core so that a magnetic flux that causes demagnetization to the plurality of permanent magnets is blocked.

2. The rotor according to claim 1, wherein each of the plurality of permanent magnets includes:
a first surface perpendicular to the radial direction of the rotor core and configured to face an inside of the rotor core;
a second surface perpendicular to the radial direction of the rotor core and configured to face an outside of the rotor core; and
a third surface configured to connect the first surface to the second surface, and
wherein each of the plurality of demagnetization prevention barriers is installed to be spaced apart from both ends of the first surface in the direction toward the outer circumferential surface of the rotor core.

3. The rotor according to claim 1, wherein each of the plurality of permanent magnets is buried in a shape of a bent protruding toward a rotation axis of the rotor core.

4. The rotor according to claim 3, wherein:
the rotor core includes a plurality of outer cores divided by each of the plurality of permanent magnets in the radial direction of the rotor core; and
each of the plurality of permanent magnets includes:
a fourth surface adjacent to the plurality of outer cores;
a fifth surface opposite to the fourth surface; and
a sixth surface configured to connect the fourth surface to the fifth surface, and
wherein each of the plurality of demagnetization prevention barriers is installed to be spaced apart from both ends of the fourth surface in the direction toward the outer circumferential surface of the rotor core.

5. The rotor according to claim 1, wherein each of the plurality of demagnetization prevention barriers is implemented as at least one of an air hole and non-magnetic material.

6. The rotor according to claim 1, wherein each of the plurality of demagnetization prevention barriers is provided to have a chamfered corner.

7. A motor, comprising:
a stator including a plurality of teeth magnetized by a plurality of coils; and
a rotor inserted in the stator to be rotatable by attraction and repulsion applied from the magnetized teeth,
wherein the rotor includes:
a rotor core provided to be rotatable by the stator;
a plurality of permanent magnets buried along a circumference of the rotor core to extend in a different direction from a radial direction of the rotor core; and
a plurality of demagnetization prevention barriers installed to be spaced apart from both ends of each of the plurality of permanent magnets in a direction toward an outer circumferential surface of the rotor core so that a magnetic flux that causes demagnetization to the plurality of permanent magnets is blocked.

8. The motor according to claim 7, wherein each of the plurality of permanent magnets extends in a direction perpendicular to the radial direction of the rotor core.

9. The motor according to claim 8, wherein each of the plurality of permanent magnets includes:
a first surface perpendicular to the radial direction of the rotor core and configured to face an inside of the rotor core;
a second surface perpendicular to the radial direction of the rotor core and configured to face an outside of the rotor core; and
a third surface configured to connect the first surface to the second surface.

10. The motor according to claim 9, wherein each of the plurality of demagnetization prevention barriers is installed to be spaced apart from both ends of the first surface in a direction toward the outer circumferential surface of the rotor core.

11. The motor according to claim 10, wherein each of the plurality of demagnetization prevention barriers is installed at a position corresponding to a demagnetization region of the both ends of the first surface.

12. The motor according to claim 7, wherein each of the plurality of permanent magnets is buried in a shape of a bent protruding toward a rotation axis of the rotor core.

13. The motor according to claim 12, wherein:
the rotor core includes a plurality of outer cores divided by each of the plurality of permanent magnets in the radial direction of the rotor core; and
each of the plurality of permanent magnets includes:
a fourth surface adjacent to the plurality of outer cores;
a fifth surface opposite to the fourth surface; and
a sixth surface configured to connect the fourth surface to the fifth surface.

14. The motor according to claim 13, wherein each of the plurality of demagnetization prevention barriers is installed to be spaced apart from both ends of the fourth surface in the direction toward the outer circumferential surface of the rotor core.

15. The motor according to claim 14, wherein each of the plurality of demagnetization prevention barriers is installed at a position corresponding to a demagnetization region of the both ends of the fourth surface.

16. The motor according to claim 7, wherein each of the plurality of demagnetization prevention barriers is implemented as at least one of an air hole and non-magnetic material.

17. The motor according to claim 7, wherein each of the plurality of demagnetization prevention barriers is provided to have a chamfered corner.

18. A method of manufacturing a motor including a stator having a plurality of teeth magnetized by a plurality of coils and a rotor including a rotor core which is rotatable by attraction and repulsion applied from the magnetized teeth, the method comprising:
burying a plurality of permanent magnets configured to extend in a different direction from a radial direction of the rotor core along a circumference of the rotor core;
determining whether a torque of the motor is equal to or greater than a target torque;
installing a plurality of demagnetization prevention barriers to be spaced apart from both ends of each of the plurality of permanent magnets in a direction toward an outer circumferential surface of the rotor core when the torque of the motor is equal to or greater than the target torque; and
reducing a thickness of each of the plurality of permanent magnets so that the torque of the motor is matched to the target torque.

19. The method according to claim 18, wherein the installing of the plurality of demagnetization prevention barriers incudes:
determining a demagnetization region of each of the plurality of permanent magnets; and
installing the plurality of demagnetization prevention barriers at a position in which an area of the demagnetization region is reduced equal to or smaller than a predetermined area.

20. The method according to claim 18, further comprising extending each of the plurality of permanent magnets by a length corresponding to the reduced thickness when the torque of the motor is matched to the target torque.
